(19) United States
(12) Patent Application Publication
(10) Pub. No.: US 2014/0286716 A1
(43) Pub. Date: Sep. 25, 2014

(54) Portable Materials Transportation System

(71) Applicants: Brian Cochrum, Fayetteville, GA (US); Drew Lofstad, Fayetteville, GA (US); Pinnacle Manufacturing, LLC, Boaz, AL (US)

(72) Inventors: Brian Cochrum, Newnan, GA (US); Drew Lofstad, Fayetteville, GA (US); Jeremy Handley, Boaz, AL (US); Randall Wright, Boaz, AL (US); Joby Satterfield, Albertville, AL (US)

(73) Assignee: Pinnacle Manufacturing, LLC, Boaz, AL (US)

(21) Appl. No.: 14/142,211

(22) Filed: Dec. 27, 2013

Related U.S. Application Data
(60) Provisional application No. 61/804,502, filed on Mar. 22, 2013.

(51) Int. Cl. B65G 53/36

(52) U.S. Cl. CPC B65G 53/36
USPC 406/122

(57) ABSTRACT

A transport and storage apparatus for loose or bulk goods, aggregate material, and liquids is disclosed herein. The apparatus is a container designed for shipping by rail, truck, or barge. Furthermore, the apparatus is of a modular shape such that multiple apparatuses may be stacked and stored together efficiently. The apparatus further includes an evacuation and vibration assembly for pneumatically disposing of stored goods in the storage compartment.

### CROSS-REFERENCE TO RELATED APPLICATIONS

This application claims the benefit of U.S. Provisional Application No. 61/804.502, filed Mar. 22, 2013.

### BACKGROUND OF INVENTION

This invention relates to portable transportation and storage equipment and more specifically to a portable storage and delivery container for loose materials, aggregate material, slurries, and liquids.

For example, loose solid materials used in construction, such as sand, gravel, or pebbles, are commonly referred to as “aggregate.” Aggregate is used in a variety of industrial contexts, including construction, mining, oil and gas drilling, civil infrastructure projects, and a wide variety of other industries. Because of the wide variety in the type of aggregate used for various industrial purposes, a number of various transport and storage methods have been devised.

Consider, for example, the supply and storage of sands used in hydraulic fracturing (or “fracking”) in oil and gas production. Fracturing (or “frac”) sand is transported and by multiple different transportation modes.

River barges can carry up to 1000 tons of frac sand and are cost efficient over long distances. However, river traffic may be shut down due to adverse weather (e.g., ice, flood conditions, or drought conditions), and transloading from a barge to another means of transportation results in high material handling costs and lost time. For overland transportation, railroad hopper cars are generally the most efficient for long distance transport of up to 100 tons of frac sand. However, like barges, railroads are often not located in close proximity to the drilling location. Therefore, high handling costs and lost time for transloading are generally incurred.

For shorter hauls, or transport from a rail or river dock to the industrial site, pneumatic trucks capable of transporting up to 25 tons are generally used. Trucks are generally much more efficient at loading and unloading that railroad hopper cars or barges. but when space at the industrial site is limited, the trucks may back up waiting to unload. This results in increased transportation costs and is inefficient use of the transporting trucks. Finally, for relatively minor amounts of sand, large sacks capable of carrying up to 1 ton of frac sand (called “super sacks”) may be used, but these tend to require excess manpower for loading and unloading and are generally unwieldy and inefficient to unload on site.

Storage of frac sand for future use can also present problems. Frac sand is typically stored at dedicated storage facilities in large silos. These facilities must be constructed and require substantial capital outlays (e.g. $15-20 million) together with periodic maintenance and inspections. This also requires additional loading and unloading at the site of the storage facility, which increases handling costs.

To address these inefficiencies in transportation and storage of frac sand and other aggregate materials, an intermodal apparatus capable of efficient loading and unloading would be desirable to reduce transportation, handling, and storage costs.

### SUMMARY OF THE INVENTION

In some respects, the invention is a transport container for loose or bulk material, the container having a frame sized and shaped for multi-mode transport; a storage compartment secured to the frame, the storage compartment comprising a valve adapted to dispose material; an evacuation tube in fluid communication with the valve and having a first end adapted to connect to a pneumatic pressure assembly; and a vibration assembly secured to the storage compartment and adapted to vibrate the storage compartment.

In other respects, the invention is a container for transporting loose or bulk material by various transport channels, the container having a modular frame configurable for transportation by rail, truck, or barge; an enclosed storage compartment secured to the frame, the compartment having a hatch for receiving material and a valve for disposing material; a ladder attached to the side of the frame; and a pneumatic assembly, the assembly having an evacuation tube located underneath the storage compartment and having a first end adapted to connect to a pneumatic pump, and a second end for disposing of material; a pneumatic vibrator secured to the side of the storage compartment and in fluid communication with the evacuation tube; and a pressure relief valve, wherein the valve on the storage compartment is in fluid communication with the evacuation tube.

In other respects, the invention is a first transport container and a second transport container. each transport container having a frame; a storage compartment secured to the frame, the storage compartment comprising a valve adapted to dispose material; and an evacuation tube in fluid communication with the valve and having a first end and a second end, wherein the first end of the second transport container evacuation tube is in fluid communication with the second end of the first transport container evacuation tube.

### BRIEF DESCRIPTION OF DRAWINGS

It should be noted that identical features in different drawings are shown with the same reference numeral.

FIG. 1 depicts a side elevation view of the transport apparatus according to one embodiment of the disclosure.

FIG. 2 depicts a top plan view of the transport apparatus according to one embodiment of the disclosure.

FIG. 3 depicts a front elevation view of the transport apparatus according to one embodiment of the disclosure.

### DETAILED DESCRIPTION

An apparatus and exemplary embodiments thereof is further described here to provide intermodal transportation and storage for aggregate material.

In general terms, the apparatus is a transmodal storage and transport apparatus for delivering and storing aggregate materials. The apparatus is designed to meet the specifications for transport by multiple modes, such by barge, rail or truck. The apparatus may have a built-in pneumatic unloading system, such that a separate unloading mechanism on the transport vehicle is not necessary. In some embodiments, the frame is “modular,” that is, the frame is designed such that the frames of multiple transport apparatuses may be stacked, linked, carried, or stored together. In this way, each transport apparatus is a separate “module” which may be independently moved or transported as desired.

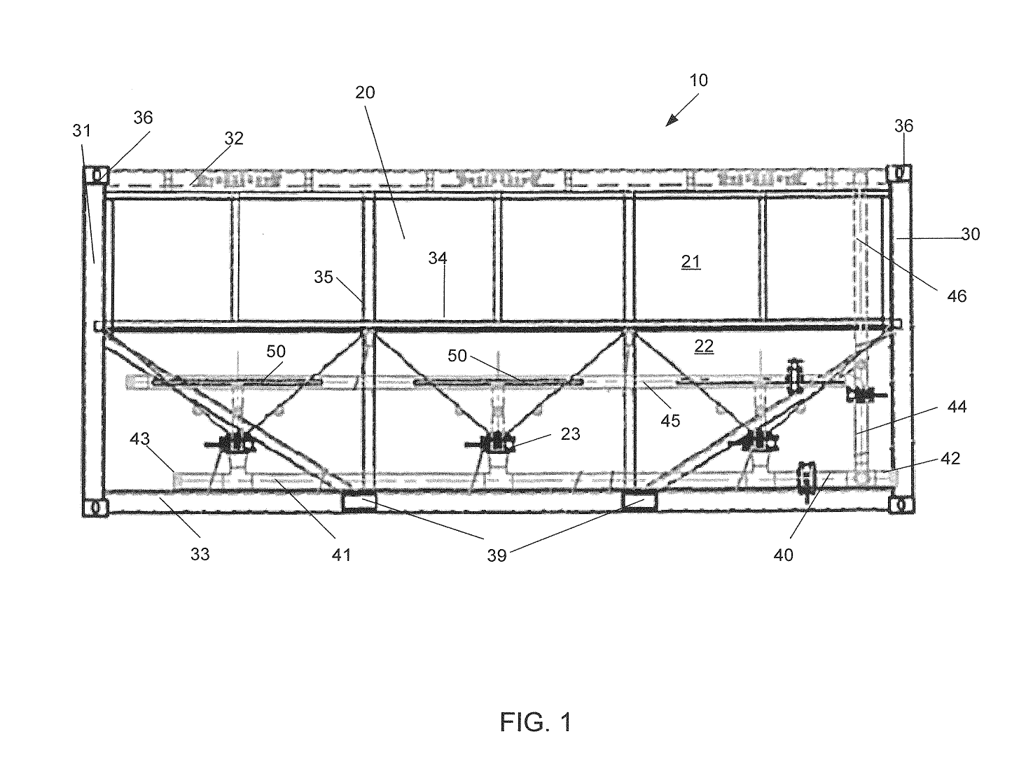

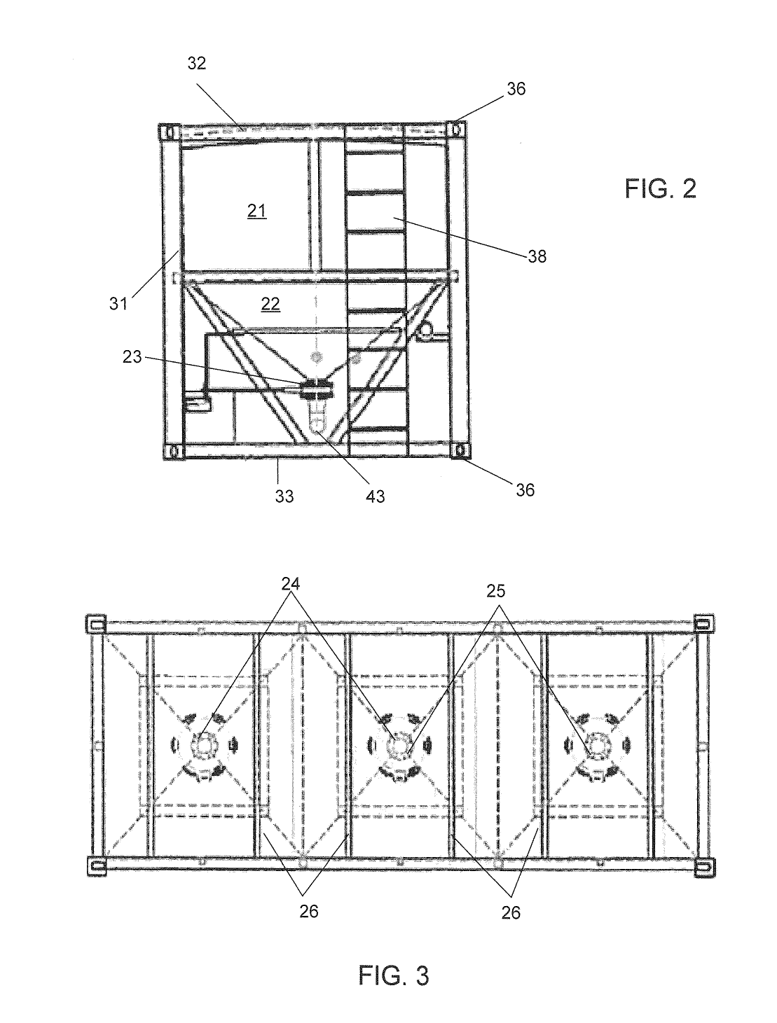

More specifically, and without limiting the foregoing general description, FIG. 1 depicts one embodiment of the transport apparatus 10. A storage compartment 20 is secured within a frame assembly 30. The storage compartment 20 has a hollow interior for storing material during storage or transport. The stored material may include loose aggregate material, such as sand or gravel, as well as other bulk goods, such as grains, liquids, or slurries. The generic term “material” will be used herein to refer to all these types of bulk goods. The storage compartment has two sections: one or more upper hopper 21 and one or more lower hoppers 22. The storage compartment depicted in FIG. 1 has a singly upper hopper 21. However, multiple upper hoppers 21 may be used without departing from the scope of this disclosure. Additionally each upper hopper 21 of the storage compartment 20 may enclose a single volume for storage, or alternatively may be subdivided into multiple sub-compartments. For example, the upper hopper 21 in FIG. 1 may be subdivided into three subcompartments, each subcompartment corresponding to and secured over a lower hopper 22. The storage container is not pressurized, and therefore is capable of handling loads of standard grain, aggregate, or liquids that do not require transport under pressure. This reduces the weight of the container, thereby decreasing both manufacturing and shipping costs.

A lower hopper 22 has a generally funnel-shaped design for directing material downward toward a valve 23 to dispose of material into the pneumatic discharge assembly 40, which is further described below. In some embodiments, the funnel shape of the lower hopper 22 may be that of an inverse pyramidal or conical shape. One or more lower hoppers 22 are situated below and secured to the upper hopper 21. In FIG. 1, three lower hoppers of a generally inverse square pyramidal shape are situated below the upper hopper 21. Together, the upper hopper 21 and lower hoppers 22 enclose a space for storing material. The space is preferably fully enclosed to prevent contamination, but it is not necessary in all embodiments. In this embodiment, the number of lower hoppers 22 was selected to maximize the storage space for material while also providing multiple valves 23 for discharge of the material, in order to increase the efficiency of the unloading process. However, any other number or design of lower hoppers 22 may be used without departing from the scope of this disclosure.

The top of the storage compartment 20 may one or more hatches 24 which may be opened to load the storage compartment 20. A hatch 24 may be configured to receive material by any appropriate mechanism. For example, the storage compartment 24 may be loaded by a standard conveyor belt used at a storage facility, which carries material to a point above the hatch 24 and then drops the material into the storage compartment 24. Alternatively, a pneumatic assembly may be used dump material through the hatch 24. Other material loading mechanisms may also be used. The hatch 24 may be weather proof to prevent contamination of the material or, if the material is solid aggregate, to prevent wetting (which can reduce the efficiency of the unloading process) as well as the interior of the storage compartment 20 from rusting. Where weatherproofing is desired, a rubber seal 25 or O-ring surrounding the hatch 24 is preferably used in order to allow the hatch 24 to be opened or closed with relative ease, though any sealing device or mechanism that can be opened or closed can be used.

The storage compartment 20 is formed of a strong, solid material capable of securely storing a large amount of material. Additionally, in some embodiments, the storage compartment 20 may provide some of the structural support within the transport apparatus 10 to support additional transport apparatuses 10 stacked on top of each other. To stack the transports, support beams 26 may be welded, bolted, or otherwise secured to the top of the storage compartment 26. The beams 26 are tall enough such that they support, together with the frame assembly 30 described below, a transport apparatus 10 stacked on top of the instant apparatus without damaging the hatch 24 or storage compartment 20. In some embodiments, the support beams are of rolled tube stock.

The storage compartment 20 is secured within a frame assembly 30. The frame assembly 30 provides external structural support to the storage compartment 20 and provides a modular form, such that the transport apparatuses 10 can be efficiently stacked or connected pneumatically. In some embodiments and as depicted in FIG. 1, the frame assembly 30 is rectangular in shape and has four columns 31, one located in each corner. The columns 31 are connected by upper beams 32 and lower beams 33 to form a rectangular prism enclosing the storage compartment 20. Additional support beams 34 and columns 35 may be used as needed to provide structural support and stability to the storage compartment 20. For maximum security and stability, the storage compartment 20 is welded to the columns 31 and 35 and to the beams 32, 33 and 34, though other methods of securing the storage compartment 20 within the frame assembly 30 may be used.

It is preferred, though not necessary, that the frame assembly 30 of each transport apparatus 10 have a corner casting locking mechanism 36 that is ISO-compliant for uniform locking capability. Corner castings 36 are located at the corners where the four corner columns 31 intersect with either an upper beam 32 or a lower beam 33. The castings 36 on the bottom of the frame assembly 30 may be used to interlock with and secure the transport apparatus 10 to either another transport apparatus 10, a railroad flatbed car, a barge, or an 18-wheeler trailer truck by use of a standard twistlock. The corner castings 36 on the top of the frame assembly 30 may secure a transport apparatus 10 stacked on top of the instant apparatus.

In order to accommodate transport by rail car or by truck, the transport apparatus 10 should be of a uniform size to fit on standard trailers or rail cars. The ISO international standard 20′ intermodal container is typically 19 feet 10.5 inches long, 8 feet wide, and 8 feet 6 inches tall, though dimensions may vary slightly. An ISO 40′ intermodal container has the same dimensions as the 20′ intermodal container, except that it is 40 feet long. It is preferred, though not necessary, that the transport apparatus 10 have overall dimensions that comply with the intermodal container specifications in order to facilitate transloading between various transportation vehicles. However, it is not necessary that the transport apparatus be intermodal compliant to be within the scope of this disclosure.

Additionally, roll-off rails 37 may be secured parallel to or below the lower beams 33. The roll-off rails 37 may be used to facilitate loading or unloading off of roll-off truck beds as are commonly used in the transportation industry. Additionally the roll-off rails 37 or the lower beams 33 may have two parallel channels 39 passing perpendicularly through them to allow a forklift to pick up and move the transport apparatus 10.

Optionally, a ladder 38 may be provided along one side of the frame assembly 30 to facilitate access to the top of the transport apparatus 10.

In some embodiments, to unload the material from the storage compartment 20, a pneumatic discharge assembly 40 is provided to blow stored material out of the storage compartment 20. The pneumatic discharge assembly 40 includes an evacuation tube 41 underneath the lower hoppers 22. Valves 23 provide a connection between the lower hoppers 22 and the evacuation tube 41 and may be opened at the appropriate time to allow the material to pass into the evacuation tube 41. At one end of the evacuation tube is an pneumatic entry port 42. The pneumatic entry port 42 may be connected to a gas pump or other pressurizer (not shown) which expels pressurized gas through the evacuation tube 41. The gas pump may be integrated into the transport apparatus 41 or connected separately. Alternatively a hose (not shown) may be connected to the exit port 43 of another transport apparatus 10, such that multiple transport apparatuses may be chained together to be unloaded simultaneously. In this configuration, the gas pump would be connected to the first transport apparatus 10 in the chain.

While a gas pump or pressurizer may provide additional efficiencies in unloading the storage compartment 20, it is not necessary in every case to rely on a pump to facilitate unloading. For example, gravity may provide sufficient force to unload the material. If bulk solid goods (e.g., aggregate or grains) are being kept in the storage compartment 20, the evacuation tube 41 may be set at an angle or slant to facilitate gravity unloading, by allowing the bulk goods to slide downward toward the exit port 43 of the evacuation tube 41. If liquids or slurries are being stored in the storage compartment 20, such angling of the evacuation tube 41 may not be necessary, as the liquid pressure inherent in the stored liquid in the storage compartment 20 may provide sufficient force to discharge the liquid or slurry.

At the second end of the evacuation tube is an exit port 43. The exit port opens to the outside and allows the material in the storage compartment to be expelled. Alternatively, the exit port 43 may be connected to a hose (not shown) to be connected to a series of transport apparatuses 10, as discussed above.

The pneumatic discharge assembly 40 may also have a branched pipe 44 that connects to either a vibration manifold pipe 45, a pressure relief pipe 46, or both. The vibration manifold pipe 45 would use the gas flow to drive a vibration manifold 50 to vibrate the lower hoppers 22, as discussed further below. The pressure relief pipe 46 would connect to a pressure relief valve 47, which would open to allow gas to vent out in the event of an unexpected pas pressure buildup within the evacuation tube 41.

A vibration manifold 50 may be included within the transport apparatus 10 to vibrate the lower hopper 22, thereby facilitating discharge. During transport, solid material tends to settle within the storage compartment 20. This is particularly the case with aggregate particles, which can become compressed against each other and restrict outflow from the storage compartment 20 when the valve 23 is opened. To loosen the aggregate and facilitate discharge, the vibration manifold 50 vibrates the lower hopper 22. This may be accomplished in any number of ways. For example, gas may be diverted from the gas pump into the vibration manifold pipe 45, which runs along the lower hopper 22. The natural vibrations from the gas pump, the evacuation tube 41, or the gas therein may be used to provide vibration to the lower hopper 22 and loosen the material. Alternatively, the gas in the vibration manifold pipe 45 may drive a separate vibration device (not shown) which provides the vibration. Also alternatively, an electrically-driven vibrator may be used, in which event a separate vibration manifold pipe 45 would not be necessary.

While the invention has been described with respect to a limited number of embodiments, those skilled in the art, having benefit of this disclosure, will appreciate that other embodiments can be devised which do not depart from the scope of the invention as disclosed here.

The claimed invention is:

1. A transport container for loose or bulk material, the container comprising:
a frame sized and shaped for multi-mode transport;
a storage compartment secured to the frame, the storage compartment comprising a valve adapted to dispose material;
an evacuation tube in fluid communication with the valve and having a first end adapted to connect to a pneumatic pressure assembly; and
a vibration assembly secured to the storage compartment and adapted to vibrate the storage compartment.

2. The container of claim 1, wherein the frame is in the shape of a rectangular box having dimensions approximately 19 feet 10.5 inches long, 8 feet wide, and 8 feet 6 inches tall.

3. The container of claim 1, wherein the storage compartment is fully enclosed, and wherein the storage compartment further comprises a hatch adapted to receive material.

4. The container of claim 3, further comprising a bar secured to the top of the storage compartment, such that the bar supports weight stacked on top of the container.

5. The container of claim 1, further comprising a ladder attached to the frame.

6. The container of claim 1, wherein the vibration assembly comprises a pneumatic vibrator secured to the side of the storage compartment.

7. The container of claim 6, wherein the pneumatic vibrator is in fluid communication with the evacuation tube.

8. The container of claim 1, further comprising a pneumatic pressure relief valve in fluid communication with the evacuation tube.

9. The container of claim 1, further comprising forklift channels passing through the frame.

10. The container of claim 1, wherein the storage compartment is subdivided into multiple subcompartments.

11. The container of claim 10, wherein each subcompartment has a valve in fluid communication with the evacuation tube.

12. The container of claim 1, wherein multiple storage compartments are secured to the frame.

13. The container of claim 1, further comprising a second end of the evacuation tube, the second end adapted to connect to a first end of an evacuation tube on a different container.

14. A container for transporting loose or bulk material by various transport channels, the container comprising:
a modular frame configurable for transportation by rail, truck, or barge;
an enclosed storage compartment secured to the frame, the compartment having a hatch for receiving material and a valve for disposing material;
a ladder attached to the side of the frame; and
a pneumatic assembly, the assembly comprising
an evacuation tube located underneath the storage compartment and having a first end adapted to connect to a pneumatic pump, and a second end for disposing of material;
a pneumatic vibrator secured to the side of the storage compartment and in fluid communication with the evacuation tube; and
a pressure relief valve,
wherein the valve on the storage compartment is in fluid communication with the evacuation tube.

15. A first transport container and a second transport container, each transport container comprising:
a frame;
a storage compartment secured to the frame, the storage compartment comprising a valve adapted to dispose material; and
an evacuation tube in fluid communication with the valve and having a first end and a second end,
wherein the first end of the second transport container evacuation tube is in fluid communication with the second end of the first transport container evacuation tube.

16. A method for delivering bulk material, the method comprising:
storing each of multiple quantities of material in separate containers, each container having a storage compartment and an evacuation tube;
causing the separate containers to be transported to a destination by a plurality of modes of transportation;
connecting the separate containers by a combined piping assembly; and
disposing of the bulk material in an intermixed manner via the combined piping assembly.
